(19) United States
(12) Patent Application Publication
(10) Pub. No.: US 2009/0257121 A1
(43) Pub. Date: Oct. 15, 2009

(54) Rotational sensitive mirror

(76) Inventor: Josh N. Hogan, Los Altos, CA (US)

Correspondence Address: Josh Hogan, 620 Kingswood Way, Los Altos, CA, 94022, US

(21) Appl. No.: 12/214,601

(22) Filed: Jun. 21, 2008

Related U.S. Application Data
(60) Provisional application No. 61/130,043, filed on May 28, 2008.
(60) Provisional application No. 61/124,169, filed on Apr. 15, 2008.

(51) Int. Cl. G02B 26/00

(52) U.S. Cl. 359/487

(57) ABSTRACT

A rotational sensitive mirror includes a low profile structure that has asymmetric reflective elements such that normally incidence polarized light is reflected with high reflectivity at least one rotational angle and that normally incidence polarized light is reflected with lower reflectivity at least one different rotational angle, thereby rotating the plane of polarization of normally incident polarized light.

### CROSS REFERENCES TO RELATED APPLICATIONS

This patent application, docket number JH080621US claims priority from provisional application 61/130,043, docket number JH080526PR, filed on the 28th. of May 2008 and also claims priority from provisional patent application No. 61/124,169 entitled “An Analysis System with Enhanced SNR” filed on 15th. Apr. 2008 both of which are incorporated by reference as if fully set forth herein.

### FIELD OF THE INVENTION

The invention relates to the field of optical components used in applications including, but not limited to, optical communications, optical data storage and optical imaging and analysis techniques such as Optical Coherence Tomography (OCT). In particular it relates to a multiple reference optical imaging and analysis systems also referred to as zonal imaging and analysis systems including, but not limited to those described in patent application Ser. No. 11/025,698 filed on 29th. Dec. 2004 titled “A Multiple Reference Analysis System”, patent application Ser. No. 11/048,694 filed on 31st. Jan. 2005 titled “Frequency Resolved Imaging” and patent application docket number JH080620US, filed on 21st. Jun. 2008 entitled “Orthogonal Reference Analysis System with Enhanced SNR”.

### BACKGROUND OF THE INVENTION

Control of polarization characteristics of optical components is a valuable technique for enhancing the performance of optical processing systems such as described in patent application docket number JH080620US, filed on 21st. Jun. 2008 entitled “Orthogonal Reference Analysis System with Enhanced SNR”.

The analysis system with enhanced SNR described in patent application docket number JH080620US includes a “rotational sensitive mirror” which is highly reflective for linearly polarized radiation at a first rotational orientation of the mirror about the axis normal to the mirror and its equivalent orientation 180 degrees from the first rotational orientation. The reflectivity of this rotational sensitive mirror decreases as it is rotated about the normal axis, reaching a minimum when it is 90 degrees rotated from the first rotational orientation.

Conventional mirrors, such as metallic mirrors or multi-layer dielectric reflective surfaces can have different reflectivities for different polarization components at non-normal angles of incidence. However, at normal incidence, they typically reflect all polarization components or polarization vectors with equal magnitude, i.e. they are isotropic at normal incidence. Mirrors based on photonic crystal structures have been developed to replace polarized beam splitters. They typically reflect one polarization and transmit the orthogonal polarization and therefore to not rotate polarization vectors.

Conventional approaches to rotating the polarization vectors or rotating the plane of polarization of linearly polarized light (at normal incidence) include wave-plates or retarders that have different velocities for different polarizations which are exploited to rotate the plane of polarization. These can be solid materials, polymers or liquid crystals. These devices typically rely on a substantial thickness to generate a significant angle of rotation and frequently need to be contained between substrates.

Faraday rotators where a medium with a significant Verdet constant causes usable polarization rotation in a magnetic field. Typically such devices again rely on a substantial thickness to generate a significant angle of rotation in practical circumstances and have the additional complexity of requiring the presence of a magnetic field.

Some applications, such as those described in patent application Ser. Nos. 11/025,698 and 11/048,694, require normal incidence and a very small distance between the polarization rotation device and an adjacent optic.

The substantial thickness of conventional rotators precludes them from being used in some such applications. Furthermore, conventional rotators typically involve multiple additional surfaces which typically generate additional reflections or require high quality additional anti-reflection coatings to minimized such reflections.

Conventional rotators also always rotate the polarization with each pass and provide no opportunity to rotate the polarization vector to a specific angle and cease to rotate further with additional passes.

There is therefore an unmet need for a single surface, single layer or low profile polarization rotator that operates to rotate the polarization vector of normally incident polarized light and ceases to rotate further with additional passes after rotating to a specific angle.

### SUMMARY OF THE INVENTION

The invention includes a rotational sensitive mirror that rotates the polarization vector of normal incidence linearly polarization light and ceases to rotate further with additional passes after rotating to a specific angle. The inventive rotational sensitive mirror comprises a low profile structure having asymmetric reflective elements operable to reflect with high reflectivity normally incident polarized light at least one first rotational angle and operable to reflect with lower reflectivity normally incident polarized light at least one second rotational angle. The preferred embodiment includes a substrate with a layer with asymmetric reflective properties. Alternate embodiments may not require a substrate.

### BRIEF DESCRIPTION OF THE DRAWINGS

FIG. 1 is an illustration of a preferred embodiment of the invention.

FIG. 2 is an illustration of the sequential systematic rotation of linearly polarized radiation by a rotational sensitive mirror.

FIG. 3 is an illustration of a photonic crystal embodiment of the invention.

### DETAILED DESCRIPTION OF THE INVENTION

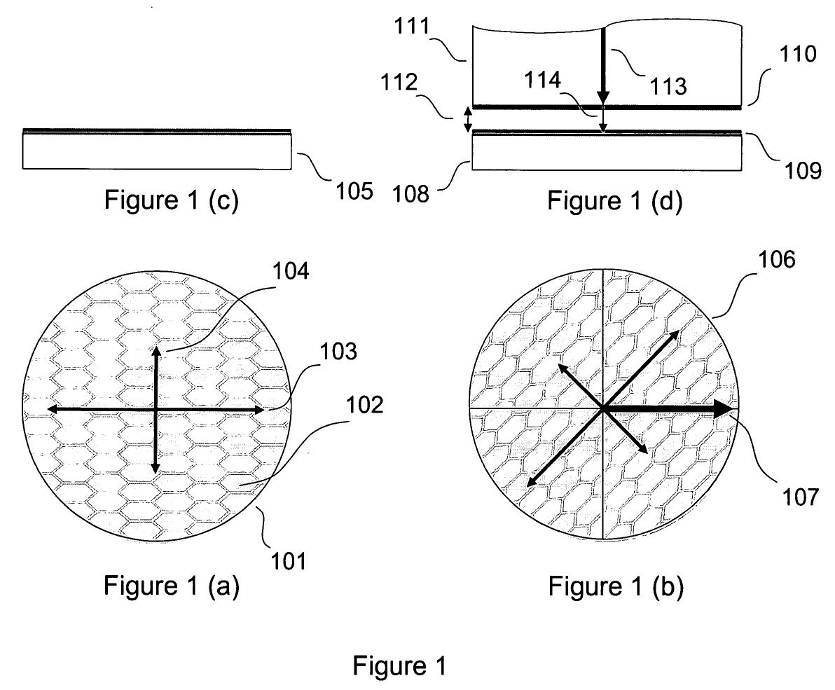

A preferred embodiment of this invention is illustrated and described with reference to FIG. 1 (a) where a reflective element 101 is shown. The reflectivity of the reflective element 101 is determined by the ability of electrons on the reflective surface to oscillate in a direction defined by the electric field of the incident light. An asymmetric pattern, one element of which is indicated by the grey element 102 is imposed on the reflective layer.

The grey asymmetric elements are highly conductive. These asymmetric reflective elements are separated by narrow (white) regions with reduced or zero conductivity. The long dimension of the asymmetric reflective elements is sufficiently long to reflect substantially all of linearly polarized light aligned with this long dimension.

The short (orthogonal) dimension reduced in magnitude to restrict the oscillation of electrons in this direction, thereby reducing the reflectivity of linearly polarized light aligned with this short dimension. The short dimension is in the general range of the order of the wavelength of light being reflected, depending on the magnitude of the desired reduction in reflectivity of linearly polarized light aligned with this short dimension.

The relative reflectivities of the high and lower reflectivity orientations are indicated by the double arrows 103 and 104 respectively. Note the dimensions of the patterns shown in FIG. 1 are for illustrative purposes and do not necessarily represent actual relative dimensions. Patterns such as those illustrated in FIG. 1 (a) can be generated by conventional techniques including, but not limited to, x-ray lithography (EUV), E-beam lithography and ion-beam lithography. A side view of a patterned reflective layer on a conventional substrate is illustrated by 105 indicating a thin patterned layer, such as a metallic layer, on a conventional non-conducting substrate, such as glass.

Operation of the reflective element of FIG. 1 (a) as a rotational sensitive mirror can be understood by considering normally incident linearly polarized light on the mirror rotated 45 degrees with respect to that illustrated in FIG. 1 (a), as depicted in FIG. 1 (b), where the rotational sensitive mirror 106 is aligned such that it has maximum reflectivity for linear polarized radiation whose polarization vector is orientated at an angle that is rotated 45 degrees from the polarization vector of the linearly polarized incident reference radiation 107.

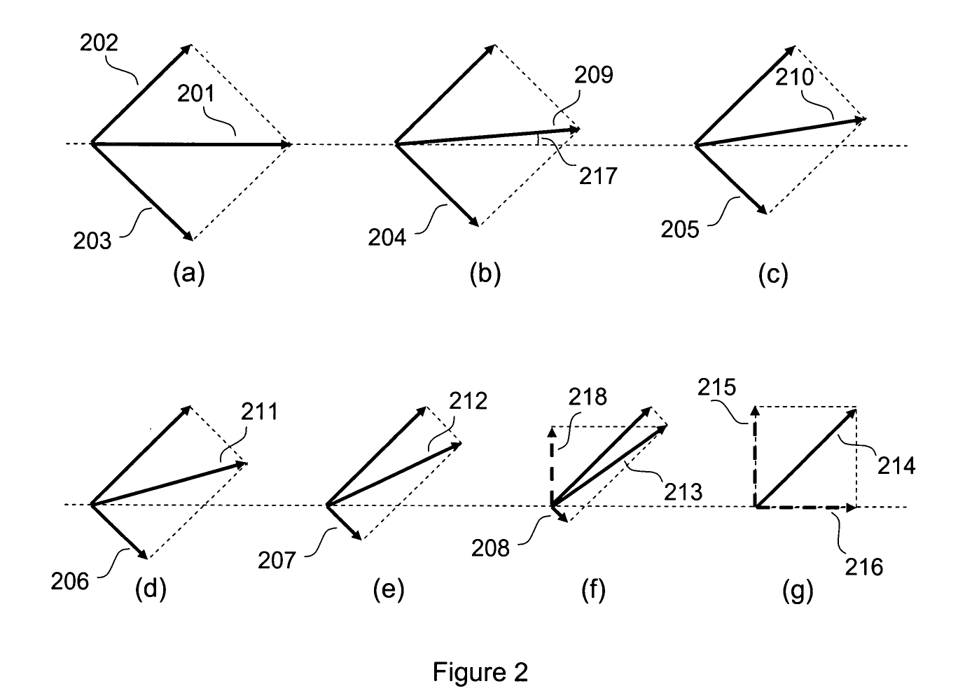

The direction of the polarization vector of the linearly polarized incident light or radiation 107 is referred to herein as the direction of the original reference radiation polarization. An example of operation of the rotational sensitive mirror, such as in the multiple reference or zonal analysis system is illustrated in FIG. 2 (d). The rotational sensitive mirror consists of a substrate 108 with a rotational sensitive reflective surface 109.

A partially reflective surface 110 on a second substrate 111 is separated by a separation distance indicated by the double arrow 112. This separation distance can be small, e.g. of the order of 50 microns depending on the specific application. In a typical application, light (original reference radiation) indicated by 113 is normally incident on the partial reflective surface 110. Normally incident light is incident at a normal or 90 degree angle of incidence with respect to the surface of the partial reflective surface 110.

A portion of this light, indicated by 114 is transmitted to be normally incident on the rotational sensitive surface 109. The light then undergoes multiple reflections between the reflective surfaces 109 and 110. At each reflection at the partial mirror 110, a portion of the light is transmitted to be available as a component of reference radiation.

The effect of the rotational sensitive mirror 106 on radiation undergoing multiple reflections between reflective elements 109 and 110 is illustrated in more detail in FIG. 2. The direction of linear polarization of the reference radiation initially incident on the rotational sensitive mirror 106 is indicated by the vector 201 of FIG. 2(a) (and is referred to as the direction of the original reference radiation polarization).

This vector can be considered as being comprised of the two orthogonal components 202 and 203. In the illustration of FIG. 2 the highly reflective orientation of the rotational sensitive mirror 106 is aligned with the component 202.

With successive reflections between the reflective surfaces 109 and 110 the component 203 that is aligned with the less reflective polarization direction is reduced in magnitude with each reflection. The lower reflectivity causes the reflective magnitude of the 203 component to be systematically reduced, as indicated by diminishing magnitude of components 203, 204, 205, 206, 207 and 208 of FIGS. 2(a), 2(b), 2(c), 2(d), 2(e) and 2(f).

A consequence of the systematic reduction of the 203 component is the systematic rotation of the total or resultant polarization vector as indicated by the rotating vectors 201, 209, 210, 211, 212, 213 and 214 of FIGS. 2(a), 2(b), 2(c), 2(d), 2(e), 2(f) and 2(g). The illustration of vector 214 in FIG. 2(g) indicates a resulting polarization vector aligned with the highly reflective orientation. In the preferred embodiment the polarization direction of further or higher order reflections will remain substantially at this orientation.

The illustration in FIG. 2 shows a polarization rotation of approximately 7.5 degrees per reflection. This is indicated by angle 217 of FIG. 2(b). The systematic rotation results in a total rotation of approximately 45 degrees with six reflections. This magnitude is for illustrative purpose only. The actual magnitude of the rotation depends on the relative reflectivity of the highly reflective and the less reflective properties of the rotational sensitive mirror surface 109. The relative magnitude of the highly and less reflective property can be selected to achieve a desired rotation per reflection to optimize for specific applications.

The illustration in FIG. 2 also shows the relative magnitude of the components 202, 203 as the 203 component systematically decreases. With each reflection at the partial reflective surface 110, which in the preferred embodiment is a partial mirror, the reference radiation reflected back to the second reflective surface 109 will be reduced in magnitude because a portion will be transmitted through the partial reflective element 110 to contribute to the reference radiation used in the detection process.

Because of the reduction in magnitude due to transmission through the partial mirror 110, both components 202 and 203 of FIG. 2(a) and their equivalents in FIG. 2(b), 2(c), 2(d), etc. will be systematically reduced in magnitude with each reflection. The component 214 of FIG. 2(g) would in practice be reduced with respect to component 202 of FIG. 2(a). In FIG. 2, component 214 is shown as being of equal magnitude with component 202 for the illustrative purpose of more clearly depicting the polarization rotation with successive reflections.

Furthermore, non-linear (trigonometric) variations in polarization rotation of successive reflections are ignored for illustrative clarity.

The magnitude of the of the reflectivity of the partially reflective surface 110 affects the relative magnitude of successive reference radiation reflections. This reflectivity magnitude and the magnitude of rotation per reflection can be selected, to optimize for the relative magnitude of reference radiation components for specific applications.

In specific imaging and analysis applications described in more detail in the patent application with docket number JH080620US, the useful reference radiation generated by successive reflections between the reflective surfaces 109 and 110 of FIG. 1 contains components that are linearly polarized in the direction orthogonal to the direction of the original reference radiation polarization. These reference radiation components can substantially pass through a polarized beam-splitter that would redirect the light polarized in the same direction as the original reference radiation polarization and thereby allows these rotated components to co-propagate with the signal radiation towards a detection system.

The magnitude of these components that pass through the polarized beam-splitter increases for higher order reflections due to the polarization rotation that occurs with successive reflections. For example, the high order radiation with rotated polarization indicated by vector 214 of FIG. 2(g) can be considered as composed of the two components 215 and 216. The component 216 is polarized along the direction of the original reference radiation.

This component 216 is therefore substantially re-directed by the polarized beam-splitter while the orthogonal component 215, however, substantially passes through the polarized beam-splitter and can co-propagate with the signal radiation a detection system.

In the illustrative example of FIG. 2, the magnitude of the useful co-propagating component 215 is 50% of the rotated reference radiation represented by 214. Since there is no further rotation for higher order reflections, such higher order reflections would also have a magnitude of the useful co-propagating component of 50% of their rotated reference radiation. In other words half of the higher order reference radiation will pass through the beam splitter to form useful co-propagating reference radiation. This may also be expressed as 50% of the available photons of the higher order reference radiation will pass through the beam splitter to form useful co-propagating reference radiation.

By comparison with 215 of FIG. 2(g), 218 of FIG. 2(f) is of lower value. This is true because for lower order reflections the magnitude of the useful co-propagating component is less than 50% of the rotated reference as indicated by the magnitude of component 218 of FIG. 2(f) and systematically decreases for lower order reflections. Note, for clarity of depiction, the other lower order components that would co-propagate are not shown. It should also be noted that these are vector quantities are illustrated in FIG. 2.

The relative magnitude of the useful co-propagating components of the rotated reference radiation generated by different order reflections can be optimized for particular applications by (a) selecting the reflectivity of the partial reflective element 110 and (b) selecting the magnitude of the rotation per reflection which in turn is influenced by the relative reflectivities of orthogonally polarized components.

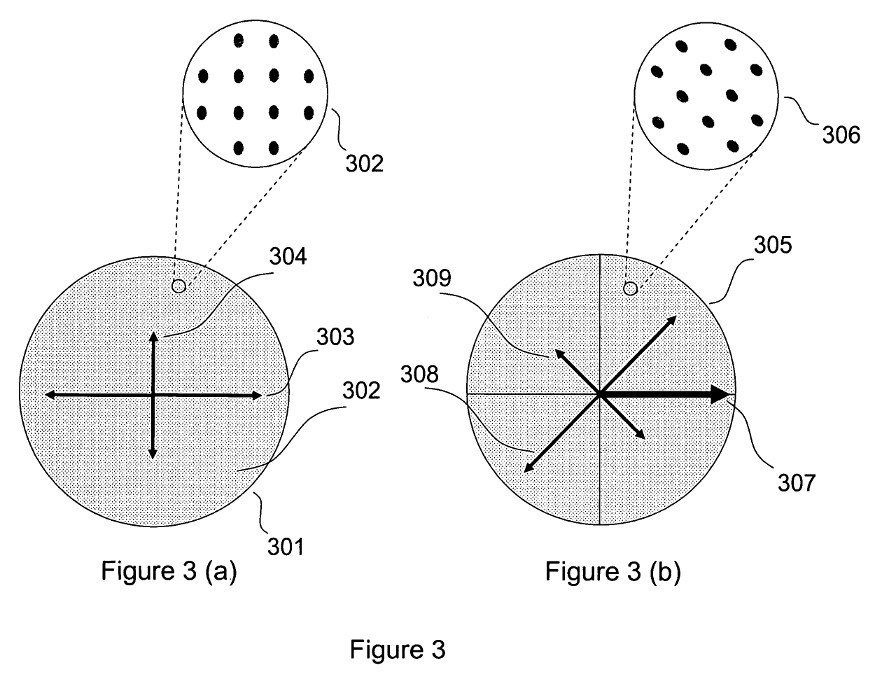

An alternative embodiment of a rotational sensitive mirror based on a photonic crystal structure is illustrated and described with respect to FIG. 3. The rotational sensitive reflective element 301 is a photonic crystal with asymmetric structural elements whose dimensions are less than the wavelength of light or radiation being reflected by the mirror.

An example of such asymmetric structural elements is shown in more detail in the expanded section 302 where oval shaped holes are on an equally spaced grid. The asymmetric aspect of the oval holes causes the reflectivity of linear polarized light to be different as indicated by the double arrows 303 and 304.

As with the preferred embodiment, if the mirror 305 is aligned so the principal axes of the oval grid, indicated in the expanded view 306, at 45 degrees with respect to the direction of incident polarized light 307, the orthogonal components aligned with the double arrows 308 and 309 reflect different amounts of the components, thereby rotating the polarization of the reflected light.

The magnitude of the rotation is determined by the difference in reflectivity of the mirror along the two directions 308 and 309. As in the preferred embodiment, multiple reflections between the rotational sensitive mirror 305 and a second reflective element causes systematic rotation of the incident linearly polarized light until a rotation of 45 degrees is achieved.

In another alternative embodiment asymmetric reflective elements related to magnetic properties of a reflective single surface or low profile structure may operate similar to the preferred embodiment. In this embodiment elements with magnetic properties including, but not limited to, atoms, molecules or nano-particles with a non-zero magnetic moment are deposited on a substrate in the presence of a magnetic field. These deposition techniques are commonly understood by those skilled in the relevant arts.

The presence of the magnetic field during the deposition process causes the elements with magnetic properties to be deposited in an aligned manner such that the reflectivity for normally incidence radiation in the aligned differs from the reflectivity for normally incidence radiation in the orthogonal direction.

The magnitude of the associated rotation per reflection is again related to the difference in the orthogonal reflectivities which can be controlled by the strength of the magnetic field and hence the degree of alignment.

In another alternative embodiment asymmetric reflective elements related to anisotropic aspects of multi-layer dielectric stacks may operate similar to the preferred embodiment. Anisotropic aspects related to layers composed of bi-axial or bi-refringent materials can introduce reflective properties such that the reflectivity for normally incidence radiation at a first rotational orientation differs from the reflectivity for normally incidence radiation at a rotational orientation 90 rotated with respect to the first rotational orientation in the orthogonal direction. Assembling layers of bi-axial materials is commonly understood by those skilled in the relevant arts including thin film deposition.

Alternatively anisotropic aspects related to obliquely deposited layers can introduce reflective properties such that the reflectivity for normally incidence radiation at a first rotational orientation differs from the reflectivity for normally incidence radiation at a rotational orientation 90 rotated with respect to the first rotational orientation in the orthogonal direction.

It is understood that the above description is intended to be illustrative and not restrictive. Many variations and combinations of the above embodiments are possible. Many of the features have functional equivalents that are intended to be included in the invention as being taught and many other variations of the above embodiments are possible.

For example, the asymmetric structural elements of the photonic crystal based mirror could be rectangular holes rather than oval or other asymmetric variations. Such asymmetric structural elements may be symmetric holes on an asymmetric grid or various combinations of asymmetric aspects, including but not limited to, asymmetric holes on asymmetric grids, and impurities rather than holes, or various combinations thereof. Various asymmetric configurations of the patterned surface of the preferred embodiment, other than that depicted in FIG. 1 are also included.

In the embodiment with elements with magnetic properties could be applied to a substrate using conventional techniques other than deposition, such as sputtering or crystal growth. Elements with magnetic properties could be embedded in polymers or other materials and aligned by a magnetic field. Increased temperature could be used to enable or assist magnetic alignment.

The embodiments and examples above describe a single surface or low profile structure that has high reflectivity for polarized light at normal incidence at least one rotational angle and has reduced reflectivity at least one other rotational angle and thereby operates to rotate the plane of polarization of normally incident polarized light.

For purposes of describing this invention, a low profile structure includes but is not limited to: a single layer; a multi-layer structure, such as used in multi-layer dielectric stacks; obliquely deposited layers or thin films; a coated surface, such as a coated substrate surface; and photonic crystal structures. “Low profile” and “thin” refer to dimensions that are small compared to the separation between a partially reflective element and the substrate, if any, supporting the rotational sensitive mirror (or their equivalents).

The low profile structure is typically but not necessarily supported by a substrate. The low profile structure may be applied to the substrate by various means including, but not limited to, vapor deposition and crystal growth processes. Whatever the means of applying the low profile structure to the substrate (or its equivalent) the low profile structure is referred to as being contained on the substrate.

Other examples of rotational sensitive mirrors will be apparent to persons skilled in the art. The scope of this invention should be determined with reference to the specification, the drawings, the appended claims, along with the full scope of equivalents as applied thereto.

What is claimed is:

1. A rotational sensitive mirror, said rotational sensitive mirror comprising:
a low profile structure, said low profile structure having asymmetric reflective elements operable to reflect with high reflectivity normally incident polarized light at least one first rotational angle and operable to reflect with lower reflectivity normally incident polarized light at least one second rotational angle.

2. The rotational sensitive mirror of claim 1, wherein the low profile structure is operable to reflect with high reflectivity normally incident linearly polarized light at least one first rotational angle and operable to reflect with lower reflectivity normally incident linearly polarized light at least one second rotational angle.

3. The rotational sensitive mirror of claim 1, wherein the low profile structure is operable to reflect with high reflectivity normally incident linearly polarized light at least one first rotational angle and operable to reflect with lower reflectivity normally incident linearly polarized light at least one second rotational angle and operable to rotate normally incident linearly polarized light incident with polarization vector aligned at a third rotational angle.

4. The rotational sensitive mirror of claim 1, wherein a said low profile structure is contained on a substrate.

5. The rotational sensitive mirror of claim 1, wherein a said low profile structure is a layer with asymmetric reflective properties.

6. The rotational sensitive mirror of claim 1, wherein a said low profile structure is a layer with asymmetric highly conductive elements.

7. The rotational sensitive mirror of claim 1, wherein a said low profile structure is a photonic crystal structure.

8. The rotational sensitive mirror of claim 1, wherein a said low profile structure includes asymmetric reflective elements associated with the alignment of magnetic properties.

9. The rotational sensitive mirror of claim 1, wherein a said low profile structure is an anisotropic layer composed of at least one bi-axial material.

10. The rotational sensitive mirror of claim 1, wherein a said low profile structure is an anisotropic layer composed of at least one bi-refringent material.

11. The rotational sensitive mirror of claim 1, wherein a said low profile structure is an obliquely deposited layer.

12. The rotational sensitive mirror of claim 1, wherein a said low profile structure is a multi-layer dielectric stack.

13. The multi-layer dielectric stack of claim 12, wherein the multi-layer dielectric stack contains an anisotropic layer.

14. The multi-layer dielectric stack of claim 12, wherein the multi-layer dielectric stack contains an anisotropic layer composed of at least one bi-axial material.

15. The multi-layer dielectric stack of claim 12, wherein the multi-layer dielectric stack layer contains at least one bi-refringent material.

16. The multi-layer dielectric stack of claim 12, wherein the multi-layer dielectric stack contains an obliquely deposited layer.
